(19) United States
(12) Patent Application Publication
(10) Pub. No.: US 2002/0131809 A1
(43) Pub. Date: Sep. 19, 2002

(54) Button binder

(76) Inventor: Nanlin Han, Los Angeles, CA (US)

Correspondence Address: Nanlin Han, 3200 Barrington Ave Apt D, Los Angeles, CA, 90066, US

(21) Appl. No.: 09/755,548

(22) Filed: Jan. 5, 2001

Related U.S. Application Data
(63) Continuation of application No. 09/484,878, filed on Jan. 18, 2000.
(60) Provisional application No. 60/163,735, filed on Nov. 16, 1999.
(60) Provisional application No. 60/174,820, filed on Jan. 7, 2000.

(51) Int. Cl. B42F 3/00

(52) U.S. Cl. 402/70

(57) ABSTRACT

The primary object of the present of invention is to provide a button binder in which paper or sheets can be easily retained and moved out, which exclude the above-mentioned disadvantages.

In accordance with one embodiment of the invention, the button binder includes several buttons, connection pieces, pulling pieces, a front sheet, a rear sheet and strips. An appropriate number of the buttons are fixed on the appropriate position on the binder, such as on the left portion or top portion of the rear sheet. The buttons mainly compromises a cap and a post. The cap has an axial hole. The post is capable of engaging in the axial hole of the cap and being fastened tightly. Punched papers or sheets can be hold by the post under the cap. When paper in the button binder is opened, there is big force to open the buttons. In order to secure the paper tightly, the buttons are designed to be opened only in a proper direction or site, and the buttons can not be opened in non-proper direction or site. Where the site of the button can be opened, the button cap and the post mesh by smooth curve faces as usual buttons. However, where the site of the button can not be opened, the button cap has tooth pawl, the button post also has latch tooth. They mesh together by teeth to firmly grasp paper. Moreover, where the button can not be opened, the button cap and post have enough touching length along the axial direction of the post, they engage by the longer contacting length (or area) along the post, the button also can not be opened from here. Another way is by latch rod of the cap and claw notch of post. The spring latch rod engages in the claw notch, the button also can not be opened from this place. To move the paper or sheets is easy and simple by a pulling action to open the proper place of the buttons, then all the button will be opened.

### CROSS-REFERENCE TO RELATED APPLICATIONS

References Cited
U.S. Pat. Documents

| | | | |
|---|---|---|---|
| 4547108 | Oct. 1985 | Nakama | 411/374 |
| 4606097 | Aug. 1986 | Lam | 24/108 |
| 5226676 | July 1993 | Su | 281/45 |
| 5445467 | Aug. 1995 | Peleman | 402/57 |
| 5644820 | July 1997 | Ho | 24/92 |
| 5660490 | Aug. 1997 | Warrington | 402/031 |

### STATEMENT REGARDING FEDERALLY SPONSORED RESEARCH OR DEVELOPMENT

Not Applicable

### REFERENCE TO A MICROFICHE APPENDIX

Not Applicable

### BACKGROUND OF THE INVENTION

The present invention relates to binders, folders and covers for holding quantities of hole punched paper or sheets to be stored and used.

The most popular binder today is still ring binder. However the structures of ring binders is somewhat complex. It needs more space to install the rings in a file. So the ring binder can not be made thin enough for just holding a few piece of paper. In addition the action of closing action of the ring binders is dangerous to user, especially for children.

The present invention has arisen to mitigate or obviate the afore-described disadvantages for the conventional ring binders.

### BRIEF SUMMARY OF THE INVENTION

The primary object of the present of invention is to provide a button binder in which paper or sheets can be easily retained and moved out, which exclude the above-mentioned disadvantages.

In accordance with one embodiment of the invention, the button binder includes several buttons, connection pieces, pulling pieces, a front sheet, a rear sheet and strips. An appropriate number of the buttons are fixed on the appropriate position on the binder, such as on the left portion or top portion of the rear sheet. The buttons mainly compromises a cap and a post. The cap has an axial hole. The post is capable of engaging in the axial hole of the cap and being fastened tightly. Punched papers or sheets can be hold by the post under the cap. When paper in the button binder is opened, there is big force to open the buttons. In order to secure the paper tightly, the buttons are designed to be opened only in a proper direction or site, and the buttons can not be opened in non-proper direction or site. Where the site of the button can be opened, the button cap and the post mesh by smooth curve faces as usual buttons. However, where the site of the button can not be opened, the button cap has tooth pawl, the button post also has latch tooth. They mesh together by teeth to firmly grasp paper. Moreover, where the button can not be opened, the button cap and post have enough touching length along the axial direction of the post, they engage by the longer contacting length (or area) along the post, the button also can not be opened from here. Another way is by latch rod of the cap and claw notch of post. The spring latch rod engages in the claw notch, the button also can not be opened from this place. To move the paper or sheets is easy and simple by a pulling action to open the proper place of the buttons, then all the button will be opened.

The button can be made of plastics or metals. The buttons can be fixed on rear sheet with out front sheet. The buttons can be fixed on a strip. The buttons can be alone to hold paper. The button cap and pulling piece can be made integrally. The button cap, connection piece and the button post can be made integrally.

### BRIEF DESCRIPTION OF THE DRAWINGS

FIG. 1 is a perspective view of one embodiment of button binder in accordance with the present invention when it is opened.

FIG. 2 is a partial cross-sectional view of a button binder with latch teeth at one side.

FIG. 3 is a partial cross-sectional view of a button binder with big contacting area at side.

FIG. 4 is a perspective view of a button cap base.

FIG. 5 is a perspective view of connection and pull piece.

FIG. 6 is a perspective view of a button cap.

FIG. 7 is a perspective view of a button post.

FIG. 8 is a perspective view of a partial rear sheet.

FIG. 9 is a perspective view of a button post base.

FIG. 10 is a perspective view of one embodiment of button binder when it is opened.

FIG. 11 is a partial cross-sectional view of the button binder with latch teeth at one side in FIG. 10.

FIG. 12 is a perspective view of a button cap base.

FIG. 13 is a perspective view of the pull piece.

FIG. 14 is a perspective view of a button cap.

FIG. 15 is a perspective view of a connection piece.

FIG. 16 is a perspective view of movable part of post of button.

FIG. 17 is a perspective view of a button post.

FIG. 18 is a perspective view of a button post base.

FIG. 19 is a partial cross-sectional view of one embodiment of the button with top hole.

FIG. 20 is a perspective view of a button cap base.

FIG. 21 is a perspective view of the button cap, pull piece and button post made integrally.

FIG. 22 is a partial cross-sectional view of one embodiment of the button.

FIG. 23 is a partial cross-sectional view of one embodiment of the button with latch rod.

FIG. 24 is a perspective view of a button cap base.

FIG. 25 is a perspective view of the connection and pull piece.

FIG. 26 is a perspective view of a button cap.

FIG. 27 is a perspective view of a curve spring rod.

FIG. 28 is a perspective view of a straight latch rod.

FIG. 29 is a perspective view of a button post with notch.

FIG. 30 is a perspective view of a button post base.

FIG. 31 is a partial cross-sectional view of one embodiment of the button whose post with two latch pawls.

FIG. 32 is a perspective view of a button cap base.

FIG. 33 is a perspective view of the connection and pull piece.

FIG. 34 is a perspective view of a button cap.

FIG. 35 is a perspective view of a string latch rod.

FIG. 36 is a perspective view of a button post with two notchs.

FIG. 37 is a perspective view of a button post base.

FIG. 38 shows the string rod and post notches are engaged.

FIG. 39 is a perspective view of a button post end.

FIG. 40 is a partial cross-sectional view of one embodiment of the button whose post locks with latch rod by big contacting area.

FIG. 41 is a perspective view of a button cap base.

FIG. 42 is a perspective view of the connection and pull piece.

FIG. 43 is a perspective view of a button cap.

FIG. 44 is a perspective view of a string latch rod.

FIG. 45 is a perspective view of a button post.

FIG. 46 is a perspective view of a button post base.

FIG. 47 is a partial cross-sectional view of one embodiment of the button whose post locked by turning latch.

FIG. 48 is a perspective view of a button cap base.

FIG. 49 is a perspective view of the turning latch.

FIG. 50 is a perspective view of a button cap.

FIG. 51 is a perspective view of a button post with a big geometry end.

FIG. 52 is a perspective view of one embodiment of button binder which buttons are fix on the left side of front sheet.

FIG. 53 is a perspective view of one embodiment of button binder which buttons are fix on the top side of rear sheet.

FIG. 54 is a perspective view of one embodiment of button binder which buttons are fix on the strip.

FIG. 55 is a perspective view of one embodiment of button binder which the button can bind paper along.

FIG. 56 is one embodiment of the button binder with a kind of connection piece.

FIG. 57 is one embodiment of the connection piece.

FIG. 58 is one embodiment of the button binder with integrally made button cup and connection piece.

FIG. 59 is one embodiment of the integrally made button cup and connection piece.

FIG. 60 is one embodiment of the integrally made button post and post base.

FIG. 61 is a partial cross-sectional view of one embodiment of the button with post and integrally made button cup and connection piece.

FIG. 62 is one embodiment of the button binder with a turning plate.

FIG. 63 is one embodiment of the binder cover and how to fold the cover.

FIG. 64 shows the position and number of buttons and types of binders.

FIG. 65 is one embodiment of the button binder with separate cap.

FIG. 66 is one embodiment of the button binder with whole piece of cap.

FIG. 67 shows several embodiments of the button binder.

FIG. 68 shows several embodiments of button posts that can be extensible.

### DETAIL DESCRIPTION OF THE INVENTION

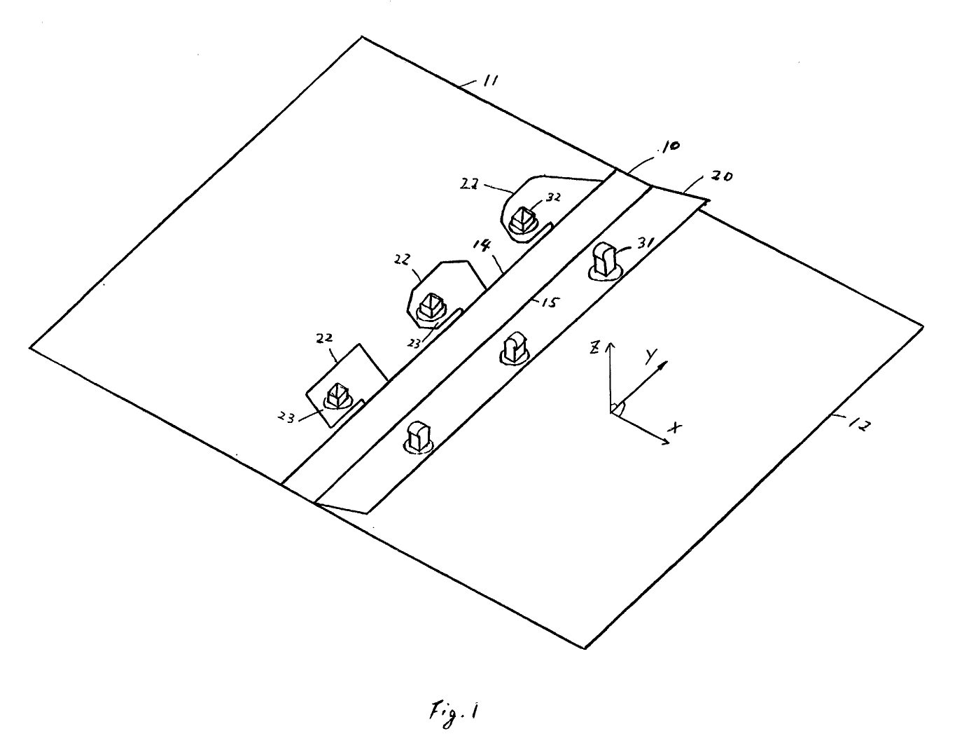

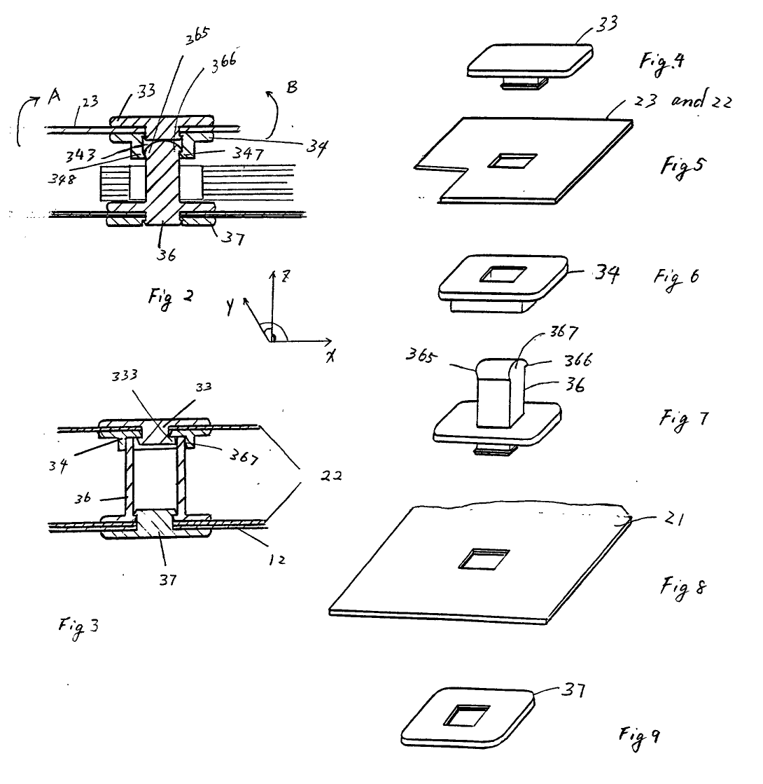

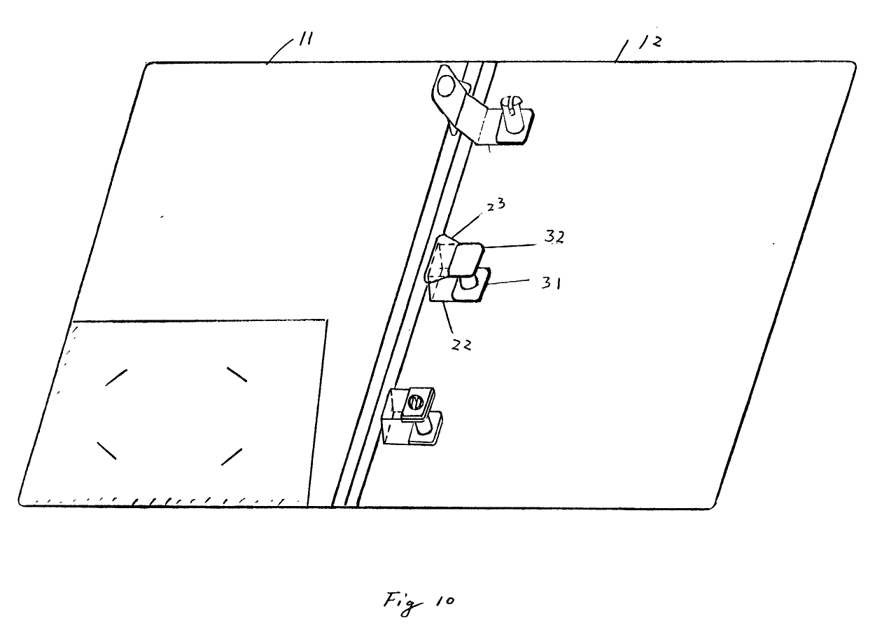

FIG. 1 illustrates a button binder 10 which includes a front sheet 11, a rear sheet 12, a strip 20, connection piece 22 having integral pull piece 23, and several buttons 30 having button cap part 32 and button post 31 are fixed on the appropriate position of the binder. The button cap parts 32 fixed on the connection piece 22 connecting to the front sheet 11 or rear sheet 12. The button post part 31 is fixed on the strip 20 or the rear sheet 12. Folding lines 14, 15 formed between the front sheet 11 and the rear sheet 12. The posts of the button post part 31 can go through the holes of punched paper or sheets. Push button cap part 32 or button post 31 to insert the post into hole of the button cap 32. They will engage tightly to hold paper between the cap part and post part of the button. To open the button cap, just pull the pulling piece 23 along latitude direction (X direction), or longitude direction (Y direction) or other proper direction depending on the direction button was installed. When the buttons are opened, the connection piece 22 keep the button cap parts connecting to the front sheet or rear sheet.

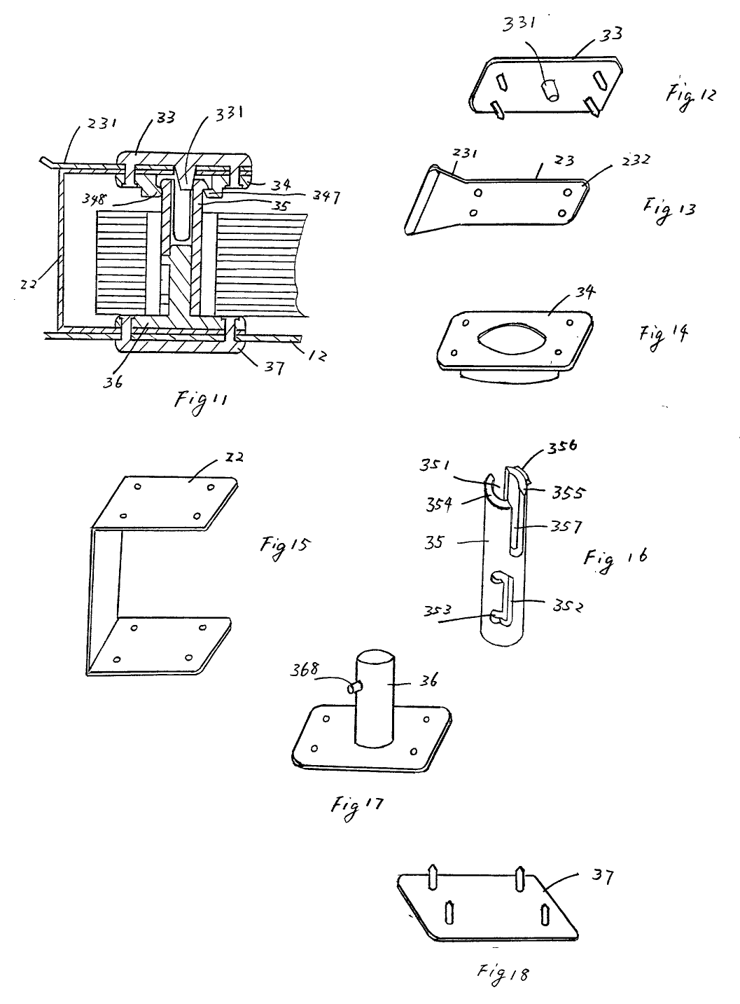

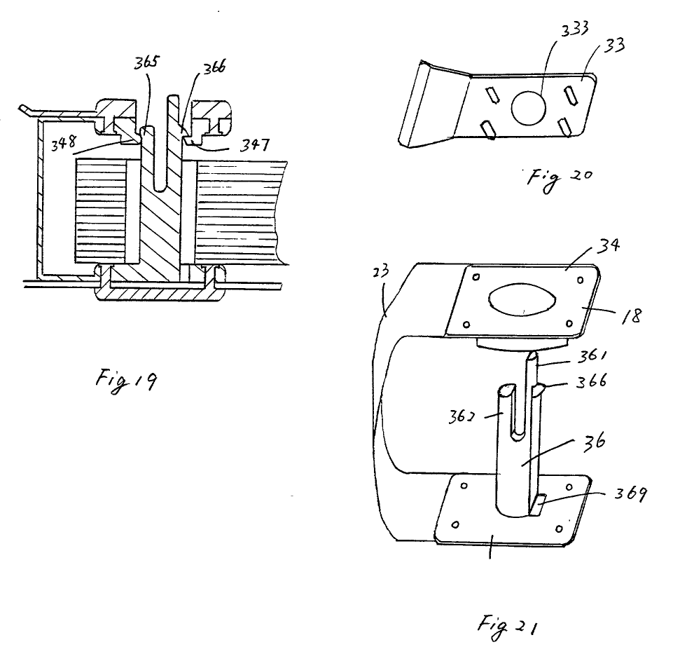

One embodiment of the button is shown in FIG. 2. From FIG. 4 to FIG. 9 show its components. The button cap part 32 comprises cap base 33 (shown in FIG. 4) and button cap 34 (shown in FIG. 6). Button post part 31 comprises button post 36 (shown in FIG. 7) and post base 37 (shown in FIG. 9). Cap base 33 and cap 34 snap on the connection piece 23 tightly. The shape of the post part 36 can be square or rectangular or other geometry shape shown in FIG. 7.

The button post 36 has bigger head at top end, which begins with smooth curved 365 from one side of the post and changes to sharp shoulder (tooth pawl) 366 when reaching the opposite side. The rest two sides of the post have flat faces 367. The cap 34 also has a square or rectangular hole respectively to the post with a mouth downwards. One side of the mouth has a smooth curve 348, and the opposite side has a sharp shoulder 347(shown in FIG. 2). The rest two sides are flat. When the post 36 engages in the hole 343 of the cap, the smooth curve surfaces 348 and 365 fit each other and the sharp shoulder ( tooth pawl) 366 and 347 latch each other. In this way, the button only can be opened from the smooth curve site in the direction pointed by arrow A, and can not be opened in the other three direction. If the tooth pawl site is also smooth curve without tooth, the button only can be opened in the two smooth curve sites, and can not be opened from the flat area sites. The cap and post contact by a little bit big flat area 367 whose length is long enough along the axis of the post. The button can not be opened from this site or direction because there is no enough space. So the buttons can be installed in the binder only if the smooth curve site or direction is not used to secure paper when paper is opened for reading (not along the direction which the paper is opened for reading). As a result, when the paper is opened for reading, the buttons are locked tightly at the same time.

FIG. 10 shows one embodiment of the button binder in which the button post 31 is fixed together with connection piece 22 on the rear sheet 12, the pull piece 23 locates just above the connection piece 22.

FIG. 11 is a partial cross-sectional view of one embodiment of button with latch teeth at one side. FIGS. 12-18 show its components. It comprises cap base33, pull piece 23, button cap 34, connection piece 22, post tube 35, post 36 and post base 37. The cap base 33 fixes pull piece 23, and cap 34 on the connection piece 22. The post base 37 fixes connection piece 22 and post 36 on the rear sheet 12. Pull piece 23 has a flap 231 extending out of button cap. Pull the flap 231 to open the button.

The post 36 is circle shape in cross section. The post tube 35 engages on the post 36 by its central hole 351. The post tube has groove notch 352. There are small holes 353 in the diameter direction at the end of groove notch 352. A short small rod 368 extending out from the button post 36 to hold post tube 35 on a proper position of itself. Twist the post tube 35 to move the rod 368 out of the hole 353 to the groove notch 352, then slide the post tube 35 along the post 36 resulting in extending the length for holding paper.

There is a bifurcated post forming a pair of posts or legs 354 and 355 at the top part of the post tube 35. The top end of leg 355 has tooth pawl 356. The another end of leg 354 is smooth curve as usual buttons. One side of the mouth of button cap 34 has a smooth curve 348, and the opposite side has a sharp tooth latch 347. When the post 36 engages in the cap 34, the smooth curve surfaces 348 and 354 fit each other and the tooth pawl 356 and 347 mesh each other. In this way, the button only can be opened from the smooth curve site. The split notch 357 between legs 354 and 355 make the two leg easy to bend into the button cap 34. The legs 354 and 355 are strong and stiff enough to stay in the button cap 34. When the button is closed, the small post 331 extending form the center of cap base 33 inserts in the split notch 357 to hold the leg 355. There is not enough space between small post 331 and leg 355 due to the length of the post 331 for opening the button at this site. This small post 331 secures the grasped site of the button. However there is enough space between small post 331 and smooth curve leg 354 for opening the button from this site.

FIG. 19 is a partial cross-sectional view of one embodiment of button. FIGS. 20 and 21 show its components. It shows that the button cap 34, connection piece 23 and button post 36 are made integrally to form a single button 18. The pull piece 23 integrally made with cap base 33. The leg 361 with the latch tooth 366 is longer than leg 362. The leg 361 can extend out of the central hole 233 of pull piece 23 when the button is closed. Use nail of finger push the end of leg 361 toward the another leg 362, the teeth 366 and 347 will open. So the button is opened. The smooth curve 365 and 348 have a lean angle in order to release their elastic force to make the button open when the teeth 366 and 347 unlocked. There is a hole 369 at the root of the post 36 which is used during manufacturing for the tooth 366.

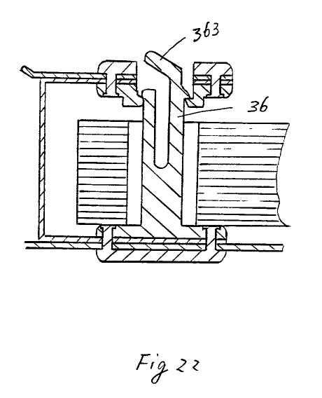

FIG. 22 is a partial cross-sectional view of one embodiment of the button similar to the embodiment shown in FIG. 19. FIG. 22 shows that there is a handle 363 at the end of leg with tooth pawl. The handle 363 has a angle with the leg 361. Open the button by pushing the handle 363.

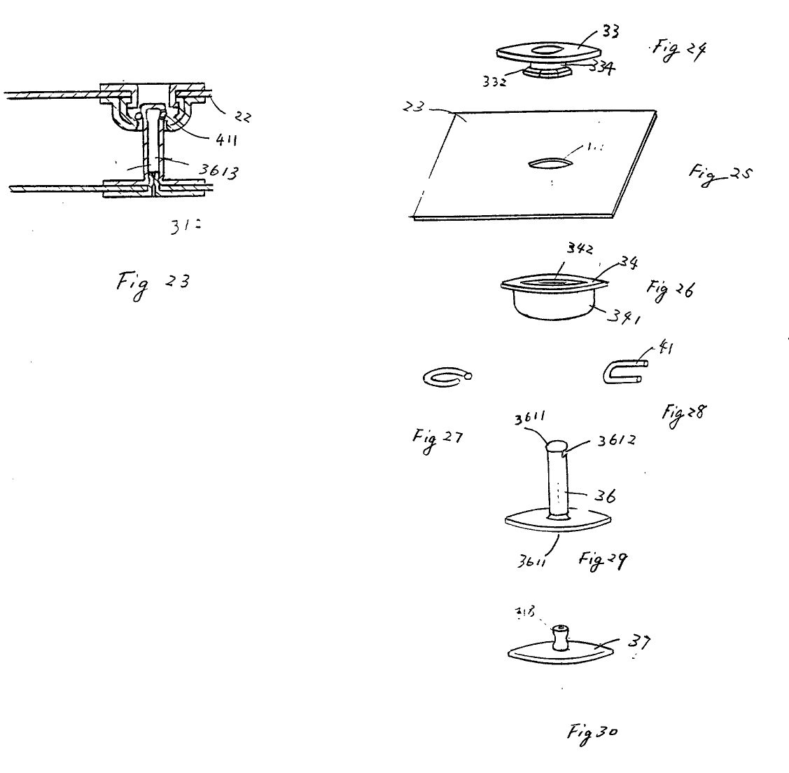

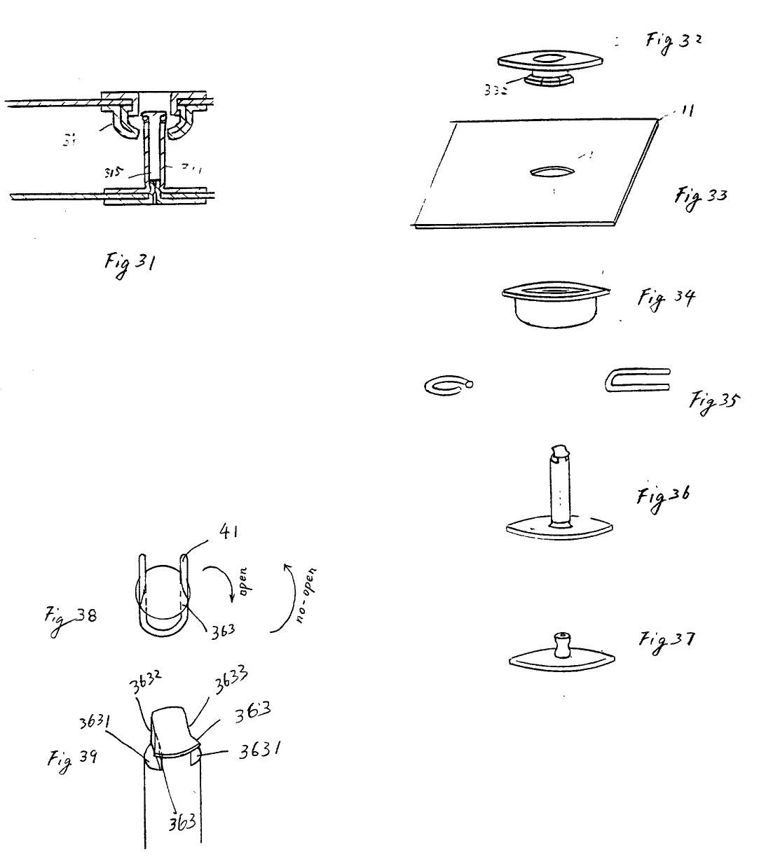

FIG. 23 is a partial cross-sectional view of one embodiment of button. FIGS. 24 to 30 show its partial components. It comprises button cap base33, pull piece 23, button cap 34, connection piece 22, spring rod 41, button post 36 and post base 37. In the center of the cap base 33, there is a projection 334 facing downwards which has a enlarged portion 332 at the end of the projection 334. The cap 34 centrally has a belly projection 341 facing downwards with a axial hole 342 which has a middle segment greater in diameter than a upper and lower segment thereof. The spring rod 41 is holed in the middle segment. The projection 334 of the base can be pressed in the hole 342 of the cap tightly through the holes of the pull piece and connection piece to fix the button cap on the connection piece.

The button post 36 is at the center of thereof. The upper end of the post 36 has a bigger head 3610 in diameter than the post 36. The post is empty with a smaller mouth 3611 downwards. The post 36 is capable of piercing in the space where the spring 41 provides. There is a latch notch 3612 near the head 3610. At the opposite side of the latch notch 3612, the head 3611 is smooth curve. A leg 411 of spring rod 41 meshes in the latch notch 3612 when the button is closed. The leg 411 is retained securely in the latch notch. Therefore, the button can not be opened from the grasped site of latch notch and spring rod. The button can be opened from the opposite smooth curve site.

The post 36 has an axial hole 3613 at itself bottom. The cap 37 also has a upward nail 372 with a bigger head which can be tightly engage in the mouth 3613 of the post 36 to fasten the button post 36 and connection piece 23 on the rear sheet 12.

FIG. 31 is a partial cross-sectional view of one embodiment of button similar to the embodiment shown in FIG. 23. FIGS. 31 to 37 show its components. The different between FIG. 31 and FIG. 23 is the head of the post 36. The new embodiment of the head of post 36 in FIG. 31 has two latch teeth 363 at half circle of the head (shown in FIG. 39). Under the two latch teeth, there are two notches 3631. The opposite half circle part 3632 of the head is without latch teeth and is smooth to the notches 3631. There are smooth curve 3633 from the latch tooth 363 transferring to no tooth head 3632. The two legs of spring rod 41 engage in the notches 3631 when the button is closed (shown in FIG. 38). Therefore the button can be opened from the side without tooth latch teeth by the legs of rod moving along the smooth curve 3633. The button can not opened at the site of latch teeth.

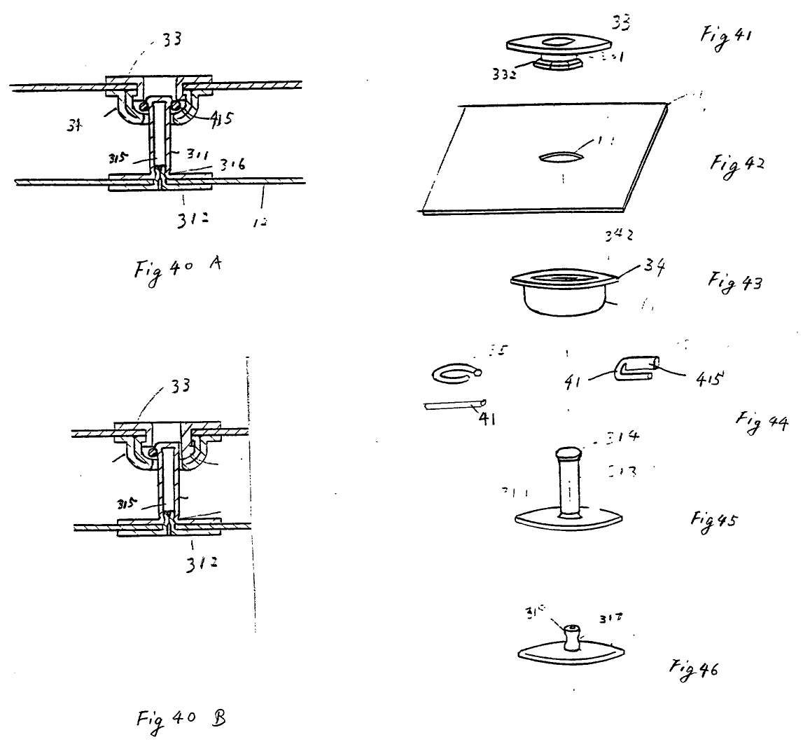

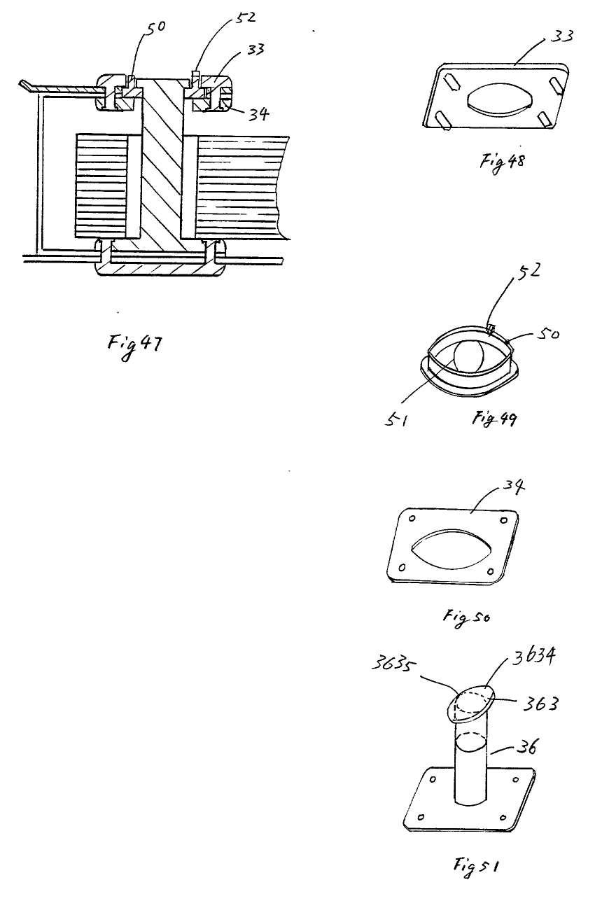

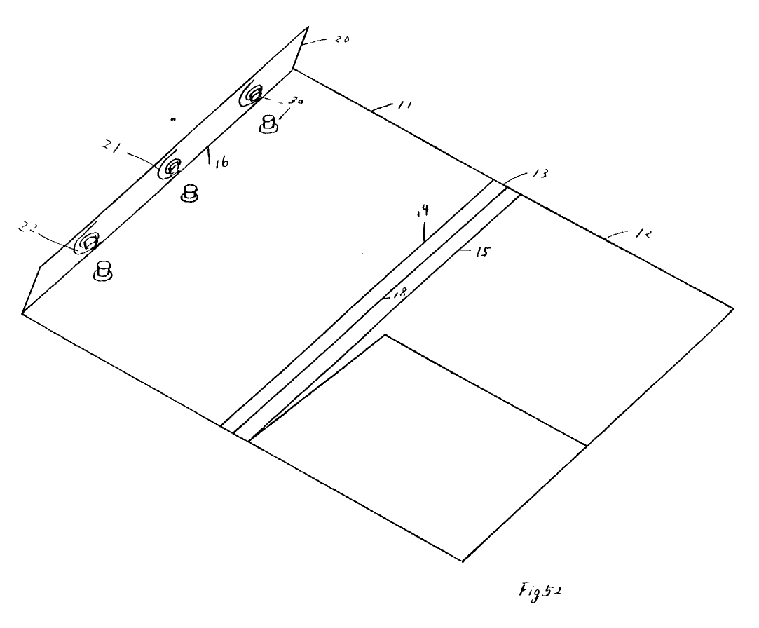

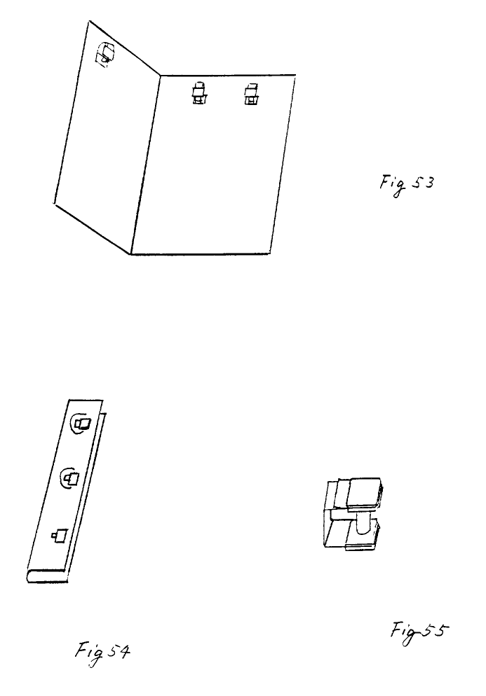

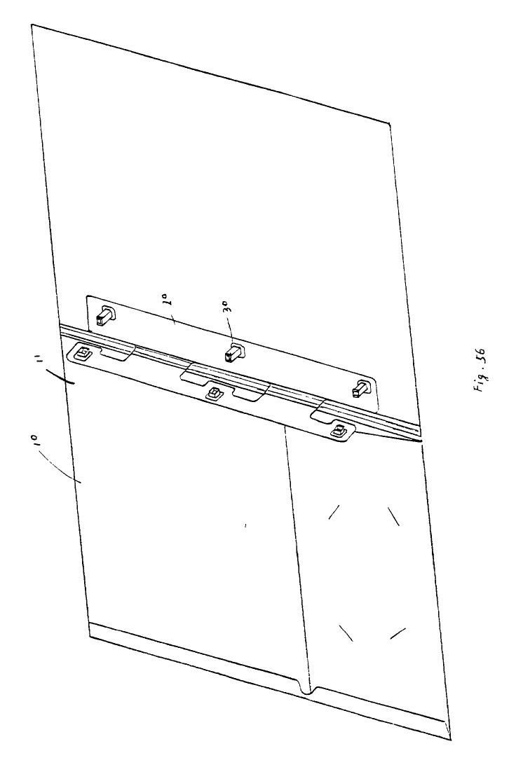

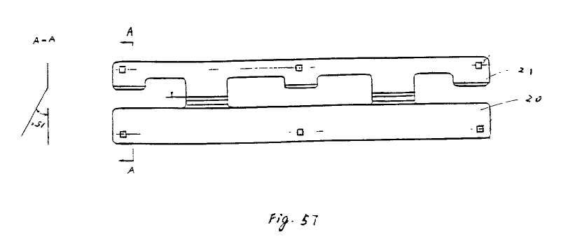

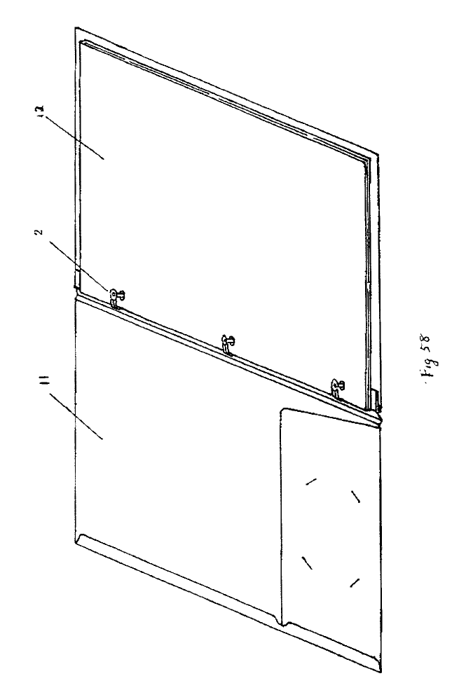

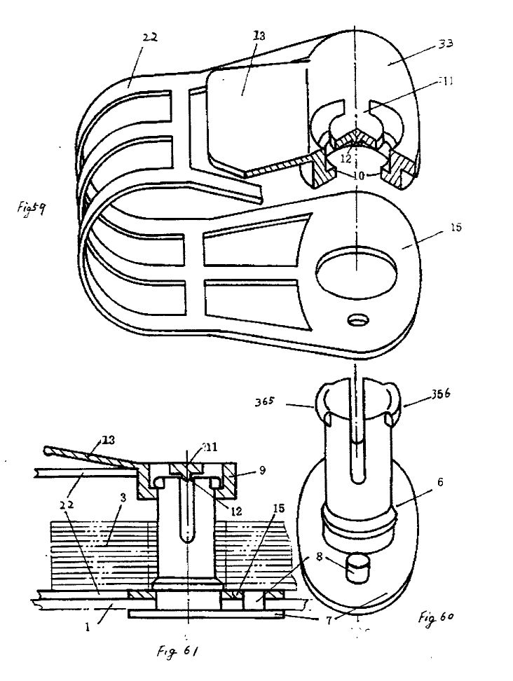

FIG. 40 is a partial cross-sectional view of one embodiment of button similar to the embodiment shown in FIG. 23 and FIG. 31. FIGS. 41 to 46 show its components. The different between FIG. 40 and FIG. 23 is the head of the post 36 and the shape of the leg of spring rod 41. The one side of the post is flat. The one leg of the spring rod is also flat piece 415. The flat area of leg and post engage together. The button can not open here. It is similar to the enough contacting length along the post mentioned above. The button also can be one side of the button post and button cap has spring rod. The opposite site of post and cap just is flat area.

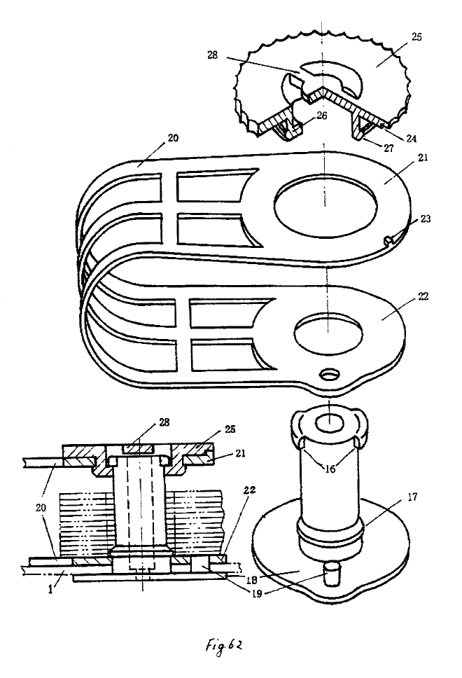

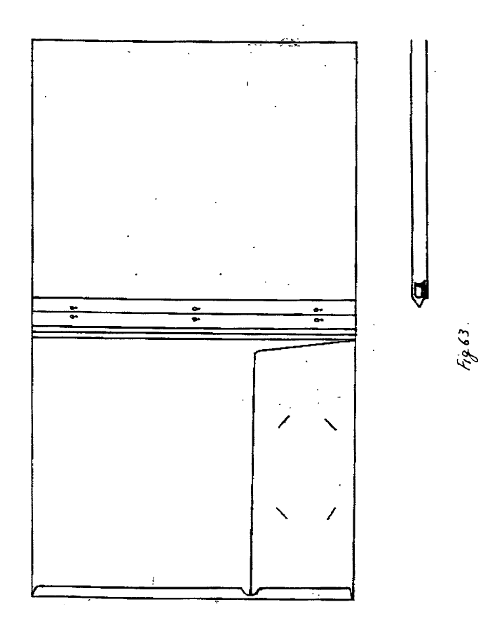

FIG. 47 is a partial cross-sectional view of one embodiment of button. FIGS. 48 to 51 show its special components. There is a turning latch plate 50 between the button cap base 33 and button cap 34. The turning latch plate can be turned within the button cap by moving the small handle 52. There is a central hole 51 in the center of the latch plate 50. The hole 51 has longer diameter in one direction and shorter diameter in other direction. For example, ollive shape. The head of the post 36 also has a latch 363 with longer diameter in one direction and shorter diameter in other direction. The shorter diameter of post 36 is shorter than the shorter diameter of the hole 51. The longer diameter of post 36 is shorter than the longer diameter of the hole 51. The longer diameter of post 36 is longer than the shorter diameter of hole 51. So the head latch 363 of post 36 can insert into the hole 51. Turn the turning latch plate 50, the latch 363 of post 36 will be locked by the shorter part of the hole 51. In this way, turn the turning plate 50 to open or lock the button.

The turning pate 50 can be modified to install on the top end of post 36 either instead of installing it between button cap and cap base.

FIG. 52 illustrates the buttons are installed at the left side of the front sheet 11 and the button cap fixed on the strip 20 which connecting to front sheet 11. The pull piece 22 is part of the strip 20.

FIG. 53 illustrates the buttons are installed at the top side of the rear sheet 12. One embodiment is that it can be only buttons and rear sheet without front sheet.

FIG. 54 illustrates the buttons are installed on a strip 20 without front sheet rear sheet.

FIG. 55 illustrates the button can hold paper alone without strip and cover sheets.

FIG. 56 is one embodiment of the button binder with a kind of connection piece.

FIG. 57 is one embodiment of the connection piece.

FIG. 58 is one embodiment of the button binder with integrally made button cup and connection piece.

FIG. 59 is one embodiment of the integrally made button cap and connection piece.

FIG. 60 is one embodiment of the integrally made button post and post base.

FIG. 61 is a partial cross-sectional view of one embodiment of the button with post and integrally made button cup and connection piece.

So the button only has two parts. The button cap and connection piece are integrally made. One end of the connection piece fix the button post on the cover.

FIG. 62 is one embodiment of the button binder with a turning plate. Turn the plate of button cap to lock or unlock the button.

FIG. 63 is one embodiment of the binder cover and shows how to fold the cover to get fold-line and the position to install buttons.

FIG. 64 shows the position and number of buttons and types of binders. The button can install on covers and strips or be used by itself

FIG. 65 is one embodiment of the button binder with separate cap.

It is a simple button cap having just a piece with dumb-bell-like holes which connect to or integrally made with connection ties, the dumb-bell hole having two cycles, one cycle with bigger diameter enough for bigger head of button post to insert, another cycle with smaller diameter enough to hole the neck of post tightly, to open the button, switch the head of post to the bigger cycle: to lock the button switch the post to the small cycle, the cap maybe just separately having one dumb-bell hole.

FIG. 66 is one embodiment of the button binder with a whole piece of cap. The cap has several dumb bell holes to match the posts.

FIG. 67 shows several embodiments of the button binder. The button posts is separately or connected by a strip. There is an optional for the button, single button still works for binding paper.

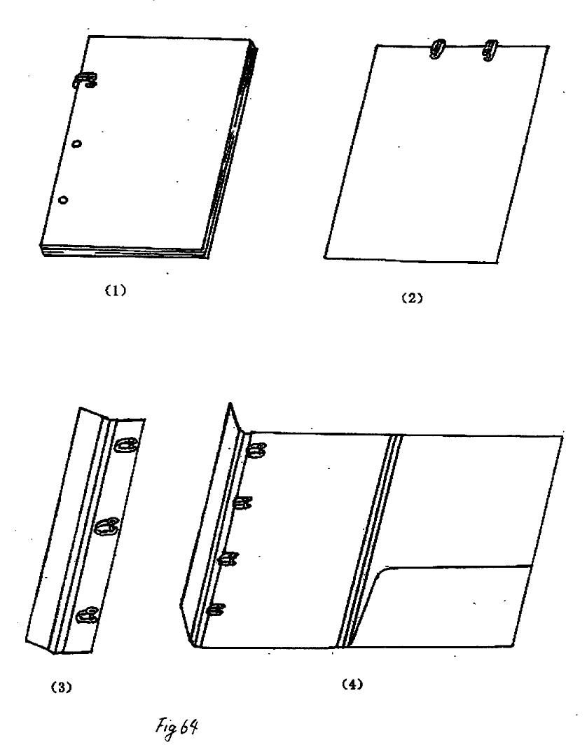

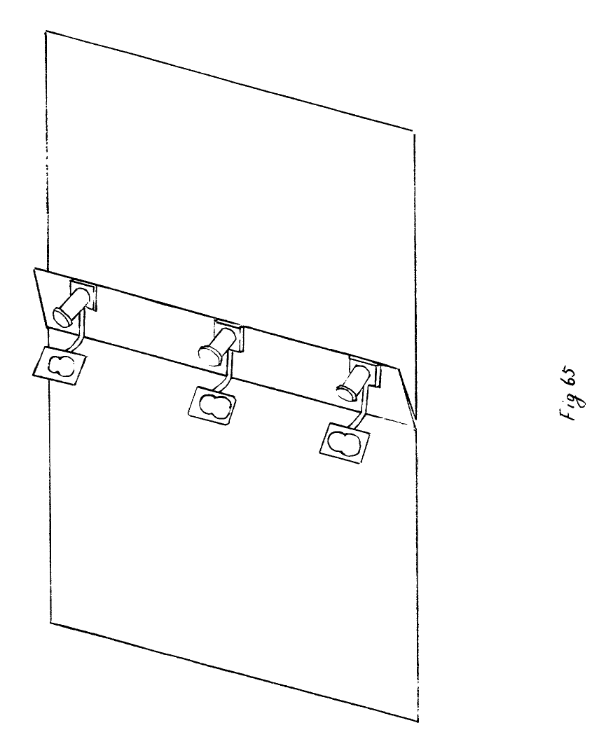

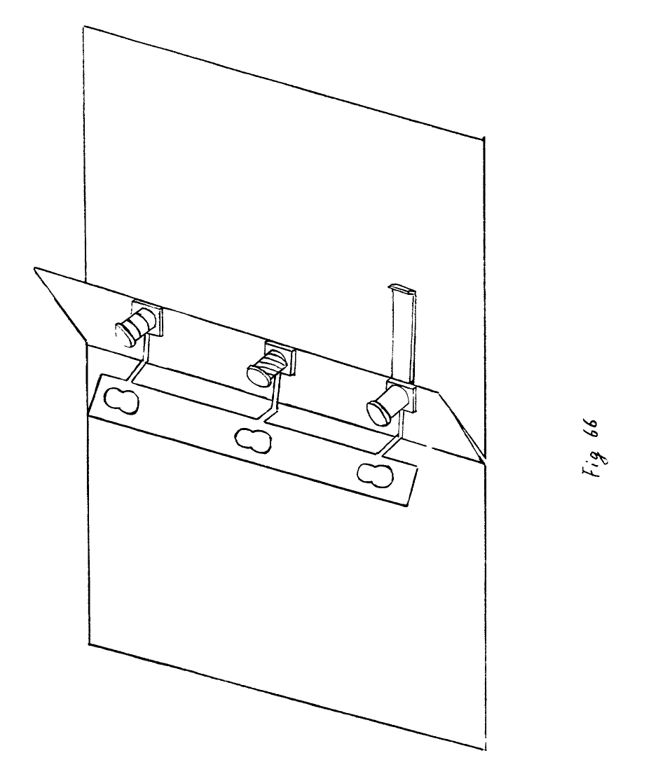

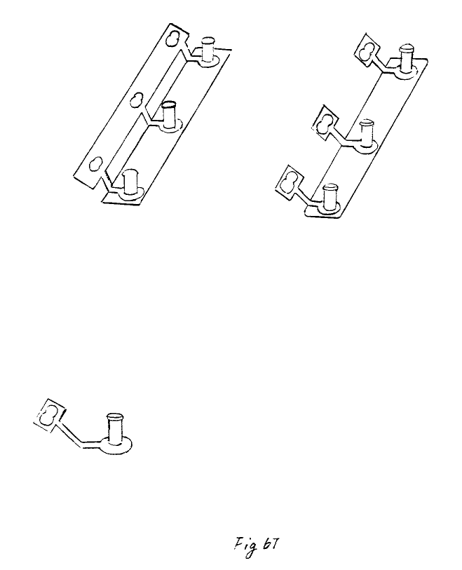

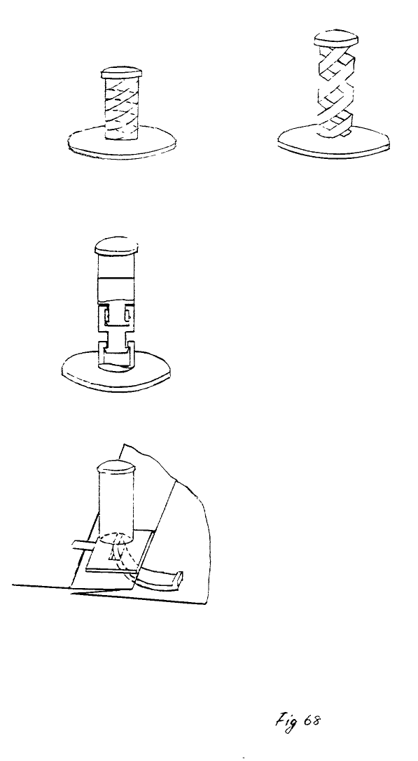

FIG. 68 shows several embodiments of button posts that can be extensible. For extensible, the button post could be spring, snap cylinder or has a tail for extending the its length, the tail inserting into a hole of post base with a bigger end, the tail moving through the hole to extend the post, the bigger end keeping the tail stay in the hole of post base, the tail made by band, tie, chain, or string.

What I claim as my invention is:

1. A button binder for apertured paper, sheet or said like, comprising in combination:
a front sheet;
a rear sheet which could be integrally made with said front sheet, where folding lines formed between said front sheet and said rear sheet;
several strips connecting to said front sheet or rear sheet at appropriate position, on which button cap part or button post part are fixed at appropriate position;
connection piece with said shape of band, string, chain or other means, useful to connect said button cap part to said button post part or said front or rear sheets or said strips when said button is opened, to keep said button cap staying on said binder;
pull piece, a small flap connecting to said button cap part and extending out from said button cap part, optionally made integrally with said button cap part, useful to pull said pull piece to open said button;
and several buttons comprising button cap part and button post part fixed on said appropriate position of said binder respectively, said button cap parts fixed on said connection piece connecting to said button post part or said front sheet or rear sheet, said button post part fixed on or connected to said strips or said rear sheet, Said button cap part optionally comprising cap base and button cap, button post part optionally comprising post base and button post with said shape of circle, square or rectangular or other geometry shape in cross section, cap base and cap fixed on said connection piece tightly, said button posts going through said holes of punched paper or sheets, pushing button cap part or button post part to insert said post head into proper position of said button cap to engage tightly to hold paper between said cap part and post part of said button, to open said button cap, pulling said pull piece, move, turn or wrench said button cap to open said button easily to permit removal or insertion of sheets from said binder, said connection piece keeping said button cap parts connecting to said front sheet or rear sheet when said buttons opened.

2. A button on the button binder according to claim 1, it comprises: cap base; pull piece; button cap; connection piece button post; post base,
said button post having said head at its top end in shape of circle, square, or other geometry shape, which begins with smooth curved from one side of said post and changes to ratchet latch or tooth pawl when reaching said opposite side, said rest two sides of said post having straight faces along said axial direction of said post, said button cap also having a circle or square or rectangular hole responding to said post with a mouth downwards, one side of said mouth having a smooth curve, and said opposite side having a tooth latch, said rest two sides are straight, said smooth curve surfaces of said cap and post fitting each other, and said tooth pawl and tooth latch of said cap and post meshing each other when said post engaging in said hole of said cap, in this way, said button only being opened from said smooth curve site or direction and not being capable of opening in said other three direction,
said buttons installed in said binder only if said smooth curve site or direction is not used to secure paper when paper is opened for reading (not along said direction which said paper is opened for reading), as a result, said buttons are locked tightly at said same time, when said paper is opened for reading.

3. According to claim 1, a button on the button binder comprises: cap base; pull piece; button cap; connection piece; button post; post base;
all components or parts capable to be made integrally,
said button post having two opposite smooth curved sides, said rest two sides of said post having straight faces along said axial direction of said post, said mouth of said button cap having two opposite sides with smooth curves, said rest two sides having straight faces along said axial direction of said post, when said button closed, said cap and post contacting by enough longer straight area at their straight sides along said axis direction of said post, not able to open said button from this side or direction because there is no enough space for opening, said buttons installed in said binder only if said smooth curve site or direction is not used to secure paper when paper is opened for reading (not along said direction which said paper is opened for reading), as a result, said buttons are locked tightly at said same time, when said paper is opened for reading,

4. A button on the button binder according to claim 1 comprises:
cap base with a downward stud nearly at its center facing down, fixing pull piece, and button cap on said connection piece,
pull piece, a flap extending out of button cap, locating just above said connection piece, pulling said flap to open said button;
button cap;
connection piece;
post base fixing connection piece and post on said rear sheet,
all components or parts capable to be made integrally, button post in circle shape in cross section, with a bifurcated post forming a pair of posts or legs and at said top part of said post, one top end of leg having tooth pawl at one side, another end of leg with smooth curve as usual buttons, one side of said mouth of button cap having a smooth curve, and said opposite side having a sharp tooth latch, said smooth curve surfaces of said post and cap fitting each other and said tooth pawls meshing each other when said legs of said post engaging in said cap, in this way, said button only capable to open from said smooth curve side or site, said split notch between said legs of said post making said two legs easy to bend into said button cap, said legs with enough strength and stiffness to stay in said button cap, said small stud downwardly extending form said center of said cap base inserting in said split notch to hold said leg where said button can not be opened, when said button is closed, because of not enough space between said stud and locking leg due to said too long length of said stud contacting said locking leg of post for opening said button at this site or side, this stud securing said grasped site of said button, however there being enough space between small stud and smooth curve leg for opening said button from that site or side,
a stud or a small bar downwardly extending form said center of said cap base inserting in said split notch to hold said leg where said button can not be opened, when said button is closed, because of not enough space between said stud and locking leg due to said too long length of said stud contacting said locking leg of post for opening said button at this site or side, this stud securing said grasped site of said button, however there being enough space between small stud and smooth curve leg for opening said button from that site or side.

5. A button binder according to claim 1 comprises: cap base; pull piece; button cap; connection piece; post tube; button post; post base, all components or parts capable to be made integrally,
said post tube with a bifurcated post forming a pair of legs at said top part of said post, one top end of leg having tooth pawl at one side, another end of leg with smooth curve as usual buttons, one side of said mouth of button cap having a smooth curve, and said opposite side having a sharp tooth latch, said smooth curve surfaces of said leg and cap fitting each other and said tooth pawls meshing each other when said legs of said post engaging in said cap, in this way, said button only capable to open from said smooth curve side or site, said split notch between said legs of said post making said two legs easy to bend into said button cap, said legs with enough strength and stiffness to stay in said button cap,
said post tube engaging on said post by its central hole, having groove notch along said axial direction of said post, with transverse holes in said diameter direction at said end of groove notch, short small rod extending out from said button post to hold post tube on a proper position of itself, twisting said post tube to move said rod out of said hole to said groove notch, then sliding said post tube along said post resulting in extending said length of said post for holding paper,
said button cap optionally having notches for easily receiving said button post.

6. A button on the binder according to claim 5 comprising:
said button cap, connection piece and button post made integrally to form a single button;
said pull piece integrally made with cap base;
and strip,
said button post in circle shape in cross section, with a bifurcated post forming a pair of posts or legs and at said top part of said post, one top end of leg having tooth pawl at one side, another end of leg with smooth curve as usual buttons, one side of said mouth of button cap having a smooth curve, and said opposite side having a sharp tooth latch, said smooth curve surfaces of said post and cap fitting each other and said tooth pawls meshing each other when said legs of said post engaging in said cap,
said leg with said latch tooth being longer than another leg, which extending out of said central hole of said cap and said cap base when said button is closed, using nail of finger to move said end of tooth leg toward said anther leg, making said teeth of said leg and cap open, so said button opened, said smooth curve face having a proper lean angle with said post in order to release their elastic force to make said button open when said teeth unlocked, a hole at said root of said post which is used during manufacturing for making said tooth,
as to another embodiment for one leg, a handle at said end of said leg with tooth pawl, having an angle with said leg of said post, which can be reached from top out side of said cap base, opening said button by pushing said handle.

7. A button on the binder according to claim 1, comprise: button cap base, pull piece, button cap, connection piece, spring rod, button post and post base,
in said center of said cap base, a projection acing downwards which has a enlarged portion at said end of said projection, Said cap centrally having a belly projection facing downwards with a axial hole which has a middle segment greater in diameter than a upper and lower segment thereof, said spring rod installed in said middle segment, pressing to make said projection of said base into said hole of said cap tightly through said holes of said pull piece and connection piece to fix said button cap on said connection piece,
said button post at said center of thereof, said upper end of said post having a bigger head in diameter than said post, said post being empty with a smaller mouth downwards, Said post being capable of piercing in said space where said spring provides, there being a latch notch near said head, at said opposite side of said latch notch, said head being smooth curve, a leg of spring rod meshing in said latch notch when said button is closed, Said leg retained securely in said latch notch, therefore, said button not to be opened from said grasped site of latch notch and spring rod, said button being capable to be opened from said opposite smooth curve site,
said post having an axial hole at itself bottom, said cap also has a upward nail with a bigger head which can be tightly engage in said mouth of said post to fasten said button post and connection piece on said rear sheet.

8. According to claim 7, a button on the button binder comprising: button cap base, pull piece, button cap, connection piece, spring rod, button post and post base,
said head of post having two latch teeth at half circle of said head, under said two latch teeth, there being two notches, said opposite half circle part of said head without latch teeth and being smooth to said notches, there being smooth curve from said latch tooth transferring to no tooth head, said two legs of spring rod engage in said notches when said button is closed, therefore said button being capable to be opened from said side without tooth latch teeth by said legs of rod moving along said smooth curve, Said button not to be opened at said site of latch teeth.

9. According to claim 8, A button on the button binder comprising: button cap base, pull piece, button cap, connection piece, spring rod, button post and post base,
said head of said post and said shape of said leg of spring rod having a straight contacting area along said axial direction of said post, straight area at one side of said post engaging with straight area of one leg of said rod, said button not be opened here, this similar to said enough contacting length along said post mentioned above,
Said button also can be one side of said button post and button cap has spring rod, Said opposite site of post and cap just is flat area,

10. According to claim 1, a button on the button binder comprising: button cap, connection piece, button post and post base, turning latch plate,
turning latch plate between said button cap base and button cap being capable to be turned within said button cap by moving said small handle, with a central hole in said center of said latch plate, said hole having longer diameter in one direction and shorter diameter in other direction, For example, said shape elongation in one direction, said head of said post also having a latch with longer diameter in one direction and shorter diameter in other direction, said shorter diameter of post shorter than said shorter diameter of said hole, said longer diameter of post shorter than said longer diameter of said hole, Said longer diameter of post longer than said shorter diameter of hole, so said head latch of post inserting into said hole, turning said turning latch plate, making said latch of post locked by said shorter part of said hole, in this way, turning said turning plate to open or lock said button.

11. A button binder according to claim 10 wherein turning latch plate can be modified to install on said top end of post either instead of installing it between button cap and cap base, turning said latch plate to open and lock said button.

12. Acording to claim 1, a simple button cap having just a piece with dumb-bell-like holes which connect to or integrally made with connection ties,
the dumb-bell hole having two cycles, one cycle with bigger diameter enough for bigger head of button post to insert, another cycle with smaller diameter enough to hole the neck of post tightly, to open the button, switch the head of post to the bigger cycle: to lock the button switch the post to the small cycle, the cap maybe just separately having one dumb-bell hole, the cap maybe having several dumb bell holes to match the posts, the button posts being separately or connected by a strip; there being an optional for the button, single button still working for binding paper.

13. According to claim 1, the button post could be spring, snap cylinder or has a tail for extending the its length, the tail inserting into a hole of post base with a bigger end, the tail moving through the hole to extend the post, the bigger end keeping the tail stay in the hole of post base, the tail made by band, tie, chain, or string.

14. According to claim 1, there being many methods and appropriate places to install appropriate number of buttons on said binder,
as to said method to install button, such as snap on, screw on, clip on, integrally made on, on strips which connecting to sheets,
as to the formation of binder, such as only rear sheet and buttons without front sheet; strip and buttons without front sheet and rear sheet; button alone,
as to materials for said binder and button, such as metal, plastic and paper.

15. According to claim 1, The connection piece, which keeps button cap connecting with binder when said button is opened, confines said direction for pushing said cap on said button post and keep said button cap opening at a big angle with said button post by the elastic of said connection piece for easily to take out or put in paper, could be a band, a string, a chain or a narrow piece.

16. According to claim 2, said direction buttons that some side can be opened and some site can not be opened at beginning should be install on said binder at proper direction in order to secure paper on said button binder.

17. According to claim 2, lock methods for said direction button could be hook and hook, latch teeth and teeth, notch and rod, between cap and post longer contacting straight length along axial direction, turning latch plate and geometry shapes.

18. A button binder according to claim 6 wherein there is a central hole at said cap and cap base for said leg extending out of said hole and for finger or nail touching said turning latch plate from top side of said button.

19. According to claim 1, the height of said button post is changeable by said sliding notch and said extending nail, spring, by screw, by snap cylinder fastener method.

20. According to claim 1, there are many position for installing buttons on said binder, such as said left part of rear sheet, said top part of rear sheet, said left part of front sheet, top part of front sheet.
